(19) United States
(12) Patent Application Publication
(10) Pub. No.: US 2026/0165387 A1
(43) Pub. Date: Jun. 18, 2026

(54) Aerosol Generation Device

(71) Applicant: JT International SA, Geneva (CH)

(72) Inventors: Alec Wright, Guildford (GB); Grzegorz Aleksander Pilatowicz, Grens (CH); Xavier Flavard, Paris (FR); Eduardo Jose Garcia Garcia, Grand-Saconnex (CH)

(73) Assignee: JT International SA, Geneva (CH)

(21) Appl. No.: 18/870,972

(22) PCT Filed: Jun. 12, 2023
(86) PCT No.: PCT/EP2023/065693

§ 371 Date: Dec. 2, 2024

(30) Foreign Application Priority Data
Jun. 13, 2022 (EP) 22178690.8

(51) Int. Cl. A24F 40/57; A24F 40/20; A24F 40/46; A24F 40/95; H05B 1/02; H05B 3/18

(52) U.S. Cl. CPC A24F 40/57; A24F 40/20; A24F 40/46; A24F 40/95; H05B 1/0252; H05B 3/18

(57) ABSTRACT

An aerosol generation device includes a holding unit configured to receive and aerosolise an aerosol generating substrate and a charging unit connectable to the holding unit. The holding unit includes a heater component configured to aerosolise the aerosol generating substrate, and a first charge storage module. The charging unit includes a second charge storage module. A controller is configured to pre-heat the heater component until a target parameter is reached by directing a second power flow from the second charge storage module to the heater component when the holding unit is connected to the charging unit, and direct a first power flow from the first charge storage module to the heater component when the holding unit is disconnected from the charging unit during pre-heating and before the target parameter is reached.

### FIELD OF THE INVENTION

The present invention relates to aerosol generation devices, and more specifically aerosol generation device power systems.

### BACKGROUND

Aerosol generation devices such as electronic cigarettes and other aerosol inhalers or vaporisation devices are becoming increasingly popular consumer products.

Heating devices for vaporisation or aerosolisation are known in the art. Such devices typically include a heating chamber and heater. In operation, an operator inserts the product to be aerosolised or vaporised into the heating chamber. The product is then heated with an electronic heater to vaporise the constituents of the product for the operator to inhale. In some examples, the product is a tobacco product similar to a traditional cigarette. Such devices are sometimes referred to as “heat not burn” devices in that the product is heated to the point of aerosolisation, without being combusted.

Problems faced by known aerosol generation devices include providing effective power management, as well as improving usability.

### SUMMARY OF INVENTION

An object of the invention is to address providing effective power management, and improving usability, amongst others.

In a first aspect, there is provided an aerosol generation device comprising a holding unit configured to receive and aerosolise an aerosol generating substrate, and a charging unit that is connectable to the holding unit;
the holding unit comprising a heater component configured aerosolise the aerosol generating substrate, and a first charge storage module configured to power the heater component;
the charging unit comprising a second charge storage module configured to power the heater component;
the aerosol generation device further comprising a controller configured to:
when the holding unit is connected to the charging unit, pre-heat the heater component until a target parameter is reached by directing a second power flow from the second charge storage module to the heater component; and
when the holding unit is disconnected from the charging unit during pre-heating and before the target parameter is reached, direct a first power flow from the first charge storage module to the heater component.

In this way, the second charge storage module in the charging unit can be used to power the pre-heating phase of an aerosolisation session. However, the holding unit can be disconnected during the pre-heating phase with the remainder of the pre-heating being powered by the first charge storage module in the holding unit. This provides the operator with flexibility in use, and effective power management.

Preferably, the first power flow corresponds to a lower current output from the first charge storage module than a current output from the second charge storage module for the second power flow.

In this way, a less powerful and therefore smaller charge storage module can be used in the holding unit. This improves usability as the size of the holding unit can be reduced.

Preferably, the target parameter is a predetermined pre-heating time.

Preferably, the controller is configured to direct the first power flow from the first charge storage module to the heater component for a modified pre-heating time when the holding unit is disconnected from the charging unit during pre-heating and before the target parameter is reached, wherein the modified pre-heating time is longer than a remaining portion of the predetermined pre-heating time at a time point when the holding unit is disconnected from the charging unit.

In this way, the pre-heating time can be adjusted when powered by only the first charge storage module in the holding unit. As such, a power management regime is provided by the heater component can still be adequately pre-heated whilst also allowing for flexibility in the operation of the device through the option to disconnect the holding unit from the charging unit during pre-heating.

Preferably, the controller is configured to determine the modified pre-heating time based upon an elapsed pre-heating time when the holding unit is disconnected from the charging unit during the pre-heating phase.

In this way, the modified heating time can be varied based upon the extent to which the heater component was pre-heated before the holding unit was disconnected from the charging unit. This ensures accurate pre-heating is maintained after disconnection of the holding unit from the charging unit.

Preferably, the controller is configured to determine the elapsed pre-heating time between the beginning of the pre-heating phase and a time point when the holding unit is disconnected from the charging unit during the pre-heating phase; and
determine the modified pre-heating time based upon the elapsed pre-heating time by a predetermined relationship between the elapsed pre-heating time and the modified pre-heating time.

Preferably, the controller is configured to maintain the heater component at a predetermined aerosolisation temperature when the heater component has been pre-heated, and the holding unit is disconnected from the charging unit, by directing a power flow from the first charge storage module to the heater component.

In this way, a larger second charge storage module can be used to (at least partially) power the pre-heating phase, saving charge in the smaller first charge storage module for the heating phase of the aerosolisation session. Then, the holding unit can be dimensioned to be smaller due to the smaller first charge storage module. This means that the operator only has to lift the smaller holding unit to their mouth for the heating phase, thereby improving usability.

Preferably, the controller is configured to maintain the heater component at a predetermined aerosolisation temperature when the heater component has been pre-heated, and the holding unit is not disconnected from the charging unit, by directing a power flow from the second charge storage module to the heater component.

In this way, charge stored in the first charge storage module can be saved for a subsequent aerosolisation session.

Preferably, when the holding unit and charging unit are connected for the heating phase, the heater component can be exclusively powered by the second charge storage module. The controller may control a power flow from the second charge storage module to the heater component, and not from the first charge storage module. In this way, the charge stored in the first charge storage module can be saved for a subsequent aerosolisation session, to allow the user to vape with the holding unit and charging unit disconnected for a longer period of time.

Alternatively, when the holding unit and charging unit are connected for the heating phase, the heater component can be powered by a combination of the second charge storage module and the first charge storage module. The controller may control power flows from both the second charge storage module and the first charge storage module to the heater component. In this way, the first charge storage module, with a smaller charge storage capacity and a lower current output, can be supplemented by a larger second charge storage module to ensure sufficient power is directed to the heater component.

Preferably, the controller is configured to, when the holding unit is connected to the charging unit, direct a power flow from the second charge storage module to the first charge storage module to charge the first charge storage module.

In this way, a two-part aerosol generation device is provided that can have a smaller and more user-friendly holding unit, for an aerosolisation session, that can also power a large number of sessions without needing to be connected to an external power source because the charging unit can recharge the holding unit between sessions.

Preferably, the holding unit comprises a cavity into which the aerosol generating substrate is insertable for heating with the heater component to generate an aerosol, wherein the cavity is configured to receive an aerosol generating substrate that is substantially planar in shape; and
the cavity comprises two major internal faces, wherein the two major internal faces oppose one another, the aerosol generating substrate is configured to be received between the opposing major internal faces, and the major internal faces are each associated with a heating element of the heater component.

Configuring the cavity to receive an aerosol generating substrate that is substantially planar or flat in shape is advantageous in that a heater component and heating cavity are provided, combined with substantially planar aerosol generation substrate, that are very compact in physical size. This improves the usability of the device by delivering a holding unit that is smaller and more comfortable for the operator to hold.

Preferably, wherein the major internal faces comprise a ceramic material and the heating elements are arranged on or embedded in the ceramic material.

In this way, a compact heating cavity is provided, with well-distributed heat directed to the substrate.

Preferably, the holding unit comprises a cavity into which the aerosol generating substrate is insertable for heating with the heater component to generate an aerosol, wherein the cavity is configured to receive an aerosol generating substrate that is rod shaped.

In this way, an aerosol generation device is provided that offers a user-experience familiar to consumers of traditional cigarettes.

Preferably, the aerosol generating substrate is a tobacco rod.

In a second aspect, there is provided an aerosol generation system comprising the aerosol generation device of the first aspect having an aerosol generating substrate received in the holding unit of the aerosol generation device.

In a third aspect, there is provided a method of operating an aerosol generation device, the aerosol generation device comprising:
a holding unit configured to receive and aerosolise an aerosol generating substrate and a charging unit that is connectable to the holding unit, the holding unit comprising a heater component configured aerosolise the aerosol generating substrate, and a first charge storage module configured to power the heater component, the charging unit comprising a second charge storage module configured to power the heater component;
wherein the method comprises:
when the holding unit is connected to the charging unit, pre-heating the heater component until a target parameter is reached by directing a second power flow from the second charge storage module to the heater component; and
when the holding unit is disconnected from the charging unit during pre-heating and before the target parameter is reached, directing a first power flow from the first charge storage module to the heater component.

The method of the third aspect can include the preferable features of the aerosol generation device of the first aspect, as appropriate.

In a fourth aspect, there is provided a non-transitory computer-readable medium storing instructions executable by one or more processors of an aerosol generation device, the aerosol generation device comprising:
a holding unit configured to receive and aerosolise an aerosol generating substrate and a charging unit that is connectable to the holding unit, the holding unit comprising a heater component configured aerosolise the aerosol generating substrate, and a first charge storage module configured to power the heater component, the charging unit comprising a second charge storage module configured to power the heater component;
wherein the instructions cause the one or more processors to perform steps comprising:
when the holding unit is connected to the charging unit, pre-heating the heater component until a target parameter is reached by directing a second power flow from the second charge storage module to the heater component; and
when the holding unit is disconnected from the charging unit during pre-heating and before the target parameter is reached, directing a first power flow from the first charge storage module to the heater component.

The non-transitory computer-readable medium of the fourth aspect can include the preferable features of the aerosol generation device of the first aspect, as appropriate.

### BRIEF DESCRIPTION OF DRAWINGS

Embodiments of the invention are now described, by way of example, with reference to the drawings, in which:

FIG. 1A is a diagram of a first exemplary aerosol generation device comprising a handpiece and a charging unit, with the handpiece removed from the charging unit;

FIG. 1B is a diagram of the first exemplary aerosol generation device comprising a handpiece and a charging unit, with the handpiece received in the charging unit; FIG. 1C is a diagram of the first exemplary aerosol generation device comprising the handpiece and a charging unit, with the handpiece pivotally connected to the charging unit;

FIG. 2 is a diagram of the handpiece of FIGS. 1A-C in more detail;

FIG. 3 is a diagram of an aerosol generating substrate configured for use with the handpiece of FIG. 2;

FIG. 4A is a diagram of a heating chamber of the handpiece of FIG. 2 with the aerosol generating substrate of FIG. 3;

FIG. 4B is a diagram of the heating chamber of FIG. 4A in more detail;

FIG. 5 is a diagram of the mouthpiece portion of the handpiece of FIG. 2 in more detail;

FIG. 6 is an exemplary plot of average power delivered to a heater against time for an aerosolisation session;

FIG. 7 is an operational flow chart of a control process for power management in an aerosolisation session;

FIG. 8A is a diagram of a second exemplary aerosol generation device comprising a handpiece and a charging unit, with the handpiece received in the charging unit; and

FIG. 8B is a diagram of the second exemplary aerosol generation device comprising a handpiece and a charging unit, with the handpiece removed from the charging unit.

### DETAILED DESCRIPTION

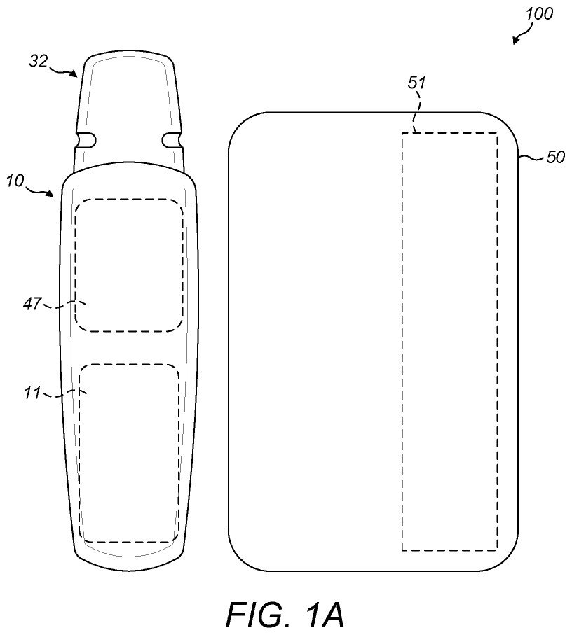

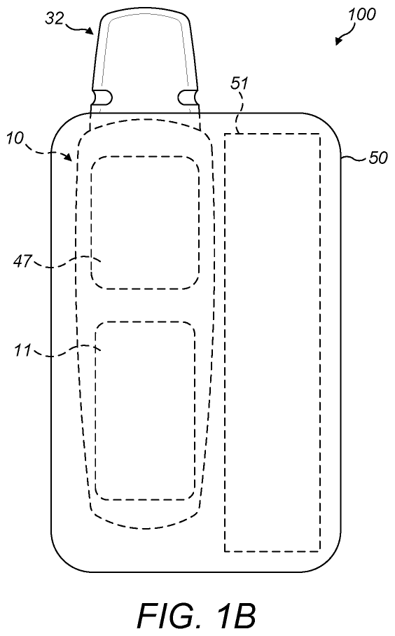

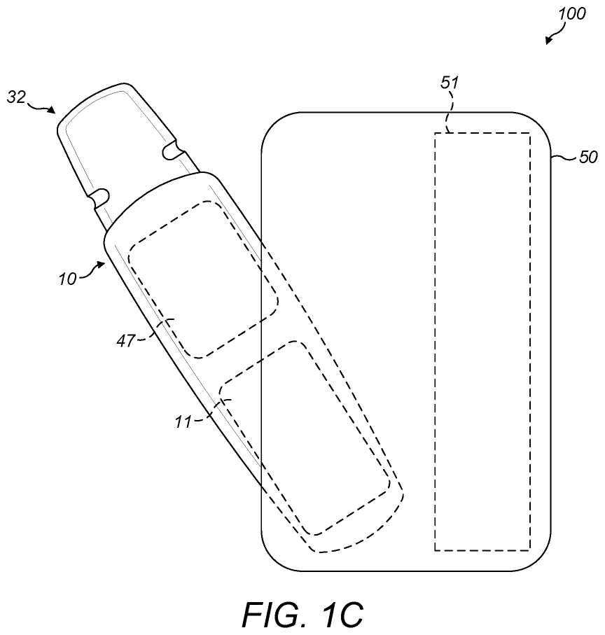

FIGS. 1A, 1B and 1C show various arrangements of a first exemplary aerosol generation device 100 (also known as a vapour generating device, vaping device, or electronic cigarette) comprising a handpiece 10 (also referred to as a holding unit) and a charging unit 50. The handpiece 10 is removably connectable to the charging unit 50.

The handpiece 10 comprises a first charge storage module 11, and a heater 47 (also referred to as a heater component). The first charge storage module 11 is configured to power the heater 47 to aerosolise an aerosol generating substrate (not shown), as described in more detail with respect to FIGS. 2 to 5. The handpiece 10 also has a mouthpiece 32 upon which an operator inhales during an aerosolisation session to inhale the generated aerosol.

The charging unit 50 comprises a second charge storage module 51 that is configured to charge the first charge storage module 11 and power the heater 47.

The first charge storage module 11 can be one or more batteries or supercapacitors, or a combination thereof. The first charge storage module 11 can be a fast-charging battery, for example a battery with chemistry such as lithium titanate (LTO). Batteries of this type are able to deliver the high current required at the beginning of an aerosolisation session and have superior safety properties.

The second charge storage module 51 can be one or more batteries or supercapacitors, or a combination thereof. In an example, the second charge storage module 51 can be a single high energy density lithium-ion battery with moderate power capability. In another example, the second charge storage module 51 can be a combination of a high energy density lithium-ion battery (or for example a battery using NMC-lithium nickel manganese cobalt oxide chemistry) with low power capabilities, and a high power battery (such as LTO, or lithium iron phosphate LFP) or a supercapacitor module.

In the following description, the first charge storage module is referred to as the handpiece battery 11, and the second charge storage module is referred to as the charging unit battery 51. However, the skilled person will readily understand that each of these can be one or more batteries, supercapacitors, or a combination thereof.

The charging unit battery 51 has a larger charge storage capacity than the handpiece battery 11. That is, the charging unit battery 51 can hold more charge the handpiece battery 11. The handpiece battery 11 may be capable of powering the heater 47 to aerosolise a first number of aerosol generating substrates, and the charging unit battery 51 may be capable of powering the heater 47 to aerosolise a second number of aerosol generating substrates, wherein the second number is greater than the first number. For example, the handpiece battery 11 may be capable of powering the heater 47 to aerosolise two aerosol generating substrates, and the charging unit battery 51 may be capable of powering the heater 47 to aerosolise twenty aerosol generating substrates.

In this way, the handpiece 10 can be dimensioned to be smaller than the charging unit 50 to be more comfortable for an operator to hold during an aerosolisation session. The larger charging unit 50 can then be used to charge the handpiece 10 between aerosolisation sessions. As such, there is a technical advantage in the provision of an aerosol generation device that has a smaller and more user-friendly handpiece 10 for aerosolisation sessions that can power a large number of sessions without needing to be connected to an external power source.

The charging unit 50 is dimensioned to receive and accommodate the handpiece 10 within an opening in the charging unit 50. The charging unit battery 51 connects by connectors in the charging unit opening to corresponding connectors in the handpiece 10 when the handpiece is received in the charging unit 50. A controller in the handpiece 10 or the charging unit 50 can detect a signal between the handpiece connectors and the charging unit connectors and control a power flow from the charging unit battery 51 to the handpiece battery 11. A power flow as discussed herein can be considered as a flow of electric charge, or a current, from one element to another. In this way, when the operator inserts the handpiece 10 into the charging unit 50, the handpiece battery 11 and charging unit battery 51 are brought into connection so that the handpiece battery 11 can be charged by the charging unit battery 51 through the connection between the connectors. As such, the charging unit 50 can be considered as a charging case for the handpiece 10. Likewise, power can flow from the charging unit battery 51 to the heater 47 by the connectors, to power the heater 47 using the charging unit battery 51.

The charging unit battery 51 can store enough charge to fully recharge the handpiece battery 11 a plurality of times. The charging unit battery 51 can itself be charged from an external power source, such as a power bank or mains source, by a connection such as a USB cable, or through connection to a docking station.

FIG. 1A shows the handpiece 10 removed from the charging unit 50 so that they are not in connection with one another. FIG. 1B shows the handpiece 10 received in and connected to the charging unit 50. In the example of FIG. 1B, the mouthpiece 32 of the handpiece 10 extends outwardly from the charging unit 50. In this way, the operator can perform an aerosolisation session whilst the handpiece 10 is housed within the charging unit 50.

Alternatively or additionally, in some examples, the charging unit 50 and handpiece 10 can be configured so that the handpiece 10 can pivot outwardly from the charging unit 50, whilst still connected to the charging unit 50, by a hinged connection at the end of the handpiece 10 away from the mouthpiece 32, as shown in FIG. 1C. This can provide greater access to the handpiece 10 whilst still connected to the charging unit 50.

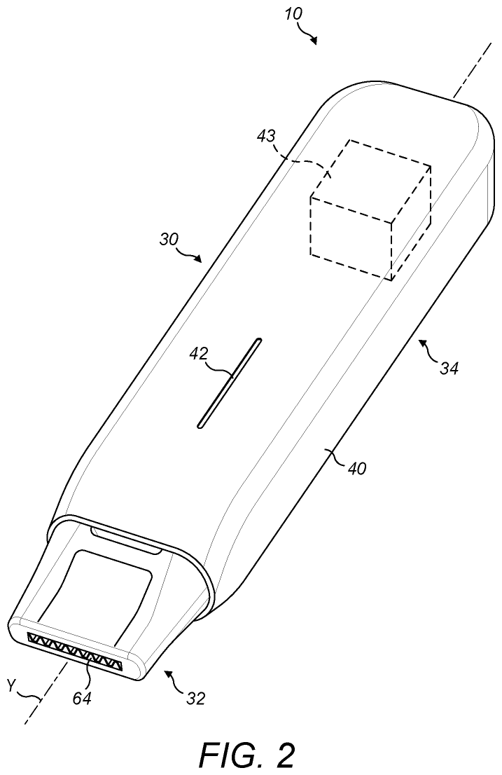

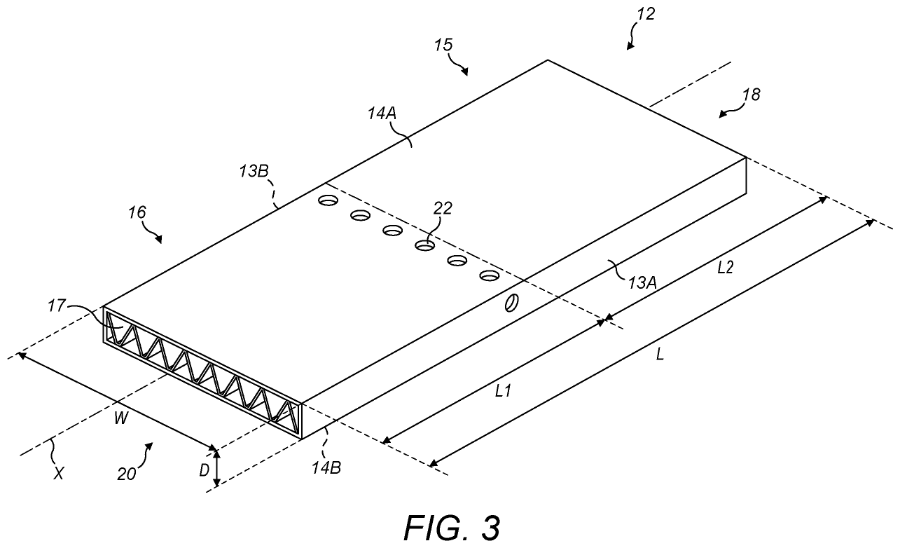

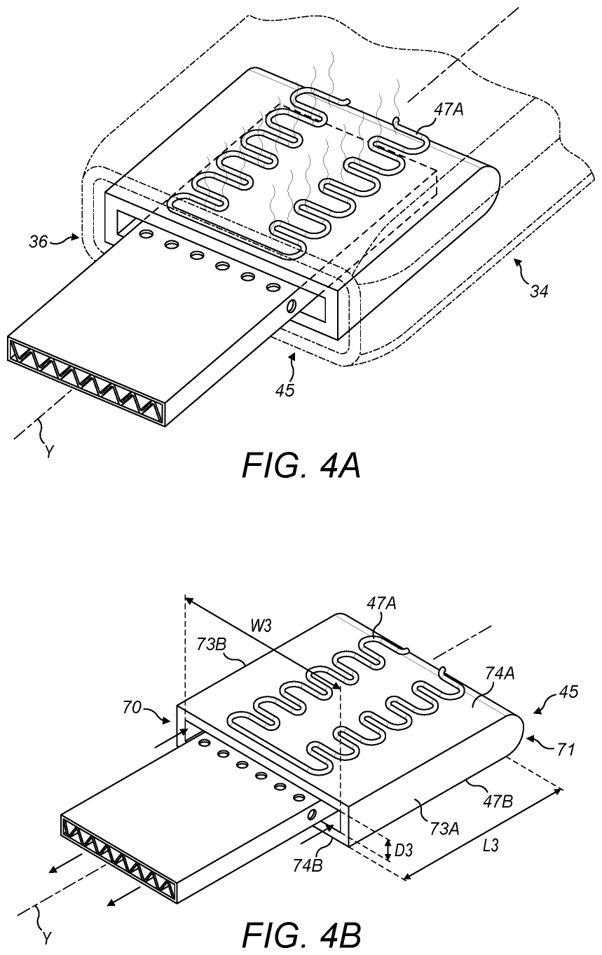

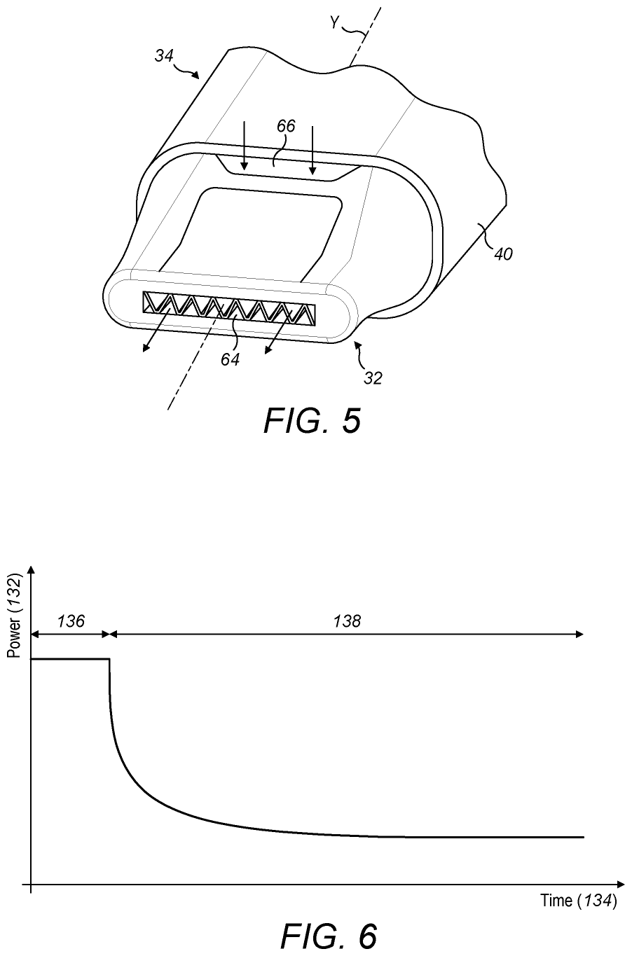

FIGS. 2 to 5 show the handpiece 10 of the first exemplary aerosol generation device 100 in more detail. FIG. 2 shows the handpiece 10 with the connected mouthpiece portion 32. FIG. 3 shows an aerosol generating substrate 12 configured for use with the handpiece 10 of FIG. 2. FIG. 4A shows a heating chamber 45 of the handpiece 10 of FIG. 2 with the aerosol generating substrate 12 of FIG. 3, and FIG. 4B shows the heating chamber 45 in more detail. FIG. 5 shows the mouthpiece portion 32 of the handpiece 10 of FIG. 2 in more detail. The aerosol generating substrate 12 is planar or flat in shape, for example in the form of flat-shaped cuboid extending along a substrate axis X and having external dimensions L×W×D. In a specific example, the length L of the substrate according to the substrate axis X equals substantially to 33 mm, width W and depth D are substantially 12 mm and 1.2 mm, respectively. That is to say, the substrate can be considered planar in shape in that it has a depth that is much shorter than the length and width.

The depth D of the substrate 12 is formed by a pair of parallel walls 13A, 13B, referred to as substrate lateral walls 13A, 13B. The width W of the substrate is formed by a pair of parallel walls 14A, 14B, referred to as substrate contact walls 14A, 14B. In other examples, the aerosol generating substrate 12 can be of other suitable shapes or dimensions. For example, the aerosol generating substrate be in of a circular tube shape, similar to a traditional cigarette.

The aerosol generating substrate 12 can comprise a heating portion 15 and a mouthpiece part 16 arranged along the substrate axis X. However, in some examples, the aerosol generating substrate 12 may comprise only the heating portion 15. The mouthpiece part has a length L1, and the heating part has a length L2. In some examples, the heating portion 15 can be slightly longer than the mouthpiece part 16, that is, L2 can be greater than L1. The heating portion 15 defines an abutting end 18 of the substrate 12 and the mouthpiece part 16 defines a mouth end 20 of the substrate 12. The heating portion 15 and the mouthpiece part 16 may be connected by a wrapper extending around the substrate axis X. Alternatively, the parts 15, 16 may be wrapped by different wrappers and fixed one to the other by any other suitable mean. The wrapper(s) can comprise paper and/or non-woven fabric and/or aluminium and/or a tobacco material (for example cigarillo paper). The wrapper(s) may be porous or air impermeable. The wrapper(s) can form a plurality of airflow channels extending inside the substrate 12 between the abutting end 18 and the mouth end 20.

The heating portion 14 is configured to be heated by a heater and comprises an aerosol generating material. The aerosol generating material can be a material that may for example comprise nicotine or tobacco and an aerosol former. Tobacco may take the form of various materials such as shredded tobacco, granulated tobacco, tobacco leaf and/or reconstituted tobacco. Suitable aerosol formers include: a polyol such as sorbitol, glycerol, and glycols like propylene glycol or triethylene glycol; a non-polyol such as monohydric alcohols, acids such as lactic acid, glycerol derivatives, esters such as triacetin, triethylene glycol diacetate, triethyl citrate, glycerin or vegetable glycerin. In some embodiments, the aerosol generating agent may be glycerol, propylene glycol, or a mixture of glycerol and propylene glycol. The substrate may also comprise at least one of a gelling agent, a binding agent, a stabilizing agent, and a humectant. When the aerosol generating material is heated, an aerosol or vapour is formed. It will be understood that the terms aerosol and vapour can be used interchangeably in this description. In an example, the aerosol generating material forms an aerosol when it is heated by the heater 47 without being burned.

The mouthpiece part 16 is intended to be received inside a mouthpiece 32. The mouthpiece part 16 comprises a core 17 that can provide a filtering functionality. In some examples, the core 17 can be a foam, or packed strands of fibres. The core 17 can be formed through an extrusion and/or rolling process into a stable shape. The substrate 12 may be shaped to provide one or more airflow channels. As shown in the example of FIG. 3, the mouthpiece part 16 can have a plurality of venting holes 22 arranged on walls of the substrate, and this can include one of more of the substrate lateral walls 13A, 13B and the substrate contact walls 14A, 14B. The venting holes 22 allow fresh air entering inside the substrate 12 to achieve particular vaping/tasting effects.

The handpiece 10 comprises a handpiece body 30 extending along a handpiece axis Y and forming at least one side wall 40 of the handpiece 10. The handpiece body 30 comprises a mouthpiece 32 and a housing 34 arranged successively according to the handpiece axis Y. In the example of FIG. 1, the mouthpiece 32 and the housing 34 form two different pieces. The mouthpiece 32 is designed to be removably fixed on, or received in, an insertion opening 36 formed at one of the ends of the housing 34. This opening 36 extends perpendicularly to the handpiece axis Y as it is shown on FIG. 4 where the mouthpiece 32 is removed from the housing 34.

In each cross section, the housing 34 may for example form a substantially rectangular shape with rounded edges, with at least four side walls 40. In other examples, the housing may have at least one different cross-sectional shape, for example a round shape. The housing 34 can be sealed at the end opposite to the insertion opening 36 receiving the mouthpiece 32. The housing 34 can be formed from a single piece or several assembled pieces made of any suitable material like aluminium or plastic. One or more side walls 40 of the housing can have one or more openings for control and/or visual elements. For example, such elements can include one or more of control buttons, touch panels, screens, LEDs, etc. In an example, the housing 34 has a slot 42 for an LED indicating at least an ON state of the handpiece 10. In some examples, the LED can also indicate status information of the handpiece such as a battery state, an error state, etc.

The housing 34 contains the handpiece battery (not shown) for powering the handpiece 10, a controller 43 for controlling the operation of the handpiece 10, a heating chamber (also referred to as a heating cavity) 45 for heating the aerosol generating substrate 12 and at least two heating elements 47A, 47B for heating the heating chamber 45.

The mouthpiece 32 is configured to connect to the insertion opening 36 while assembling the mouthpiece 32 with the housing 34

The mouthpiece 32 has a through-hole along the handpiece axis Y designed to receive the mouthpiece part 16 of the aerosol generating substrate 12 so that the substrate axis X coincides with the handpiece axis Y. The through-hole can have the same cross-sectional shape as the aerosol generating substrate 12 with internal dimensions slightly greater than the external dimensions of the mouthpiece part 16 of the aerosol generating substrate 12. In an example, the through-hole defines a rectangular cross-section for receiving the mouthpiece part 16 of the aerosol generating substrate 12.

The mouthpiece 32 can have a recessed portion so that when the mouthpiece 32 is inserted in the insertion opening 36, the recess portion forms an opening 66 forming a flow inlet 66. Alternatively or additionally, through-holes can be arranged in sidewalls of the device to provide a channel for air to flow in the heating chamber. Where the aerosol generating substrate 12 comprises the venting holes 22, at least some of these venting holes 22 are arranged to face the flow inlet 66.

In some cases, the substrate 12 may not include the venting holes 22; in such cases the air can flow into the substrate by being drawn in through the abutting end 18. For example, air can be drawn into the device through a flow inlet 66 in the mouthpiece 32, or sidewalls of the device, to counteract a pressure drop caused by the operator inhaling open the mouthpiece 32. This airflow can be drawn through a channel alongside or around the substrate 12, and into the substrate 12 through the end 18 opposite to the mouth end 20. The mouth end 20 is arranged in, or proximal to, the mouthpiece 32 and is the end of the substrate 12 nearer to the operator's mouth, in use. The airflow is then drawn through the substrate 12 where it mixes with the generated aerosol, passes out of the mouth end 20, through the mouthpiece 32, and flows into the mouth of the operator.

Turning to FIGS. 4A and 4B in more detail, the heating chamber 45 can be cup-shaped and extend along the handpiece axis Y between an open end 70 into which the aerosol generating substrate 12 is inserted, and an opposing sealed end 71. The heating chamber 45 receives the heating portion 15 of the aerosol generating substrate 12. The heating chamber 45 has substantially the same cross-sectional shape as the aerosol generating substrate 12. In an example, the heating chamber 45 defines a rectangular cross-sectional shape with two parallel chamber lateral walls 73A, 73B and two parallel chamber contact walls 74A, 74B. The walls 74A, 74B form two major internal faces in the chamber 45, and oppose one another; the aerosol generating substrate is configured to be received between these opposing major internal faces. The major internal faces each comprise a heating element 47A, 47B of the heater component 47. The walls 73A, 73B form two minor internal faces of the chamber, connecting the two major internal faces. The two minor internal faces are smaller than the two major internal faces, and the cavity is configured to receive an aerosol generating substrate that is substantially planar in shape. Each chamber wall 74A, 74B is for example at least 3 times, advantageously 5 times and more advantageously 8 times, wider than each chamber wall 73A, 73B.

The heating chamber 45 has a distal wall arranged perpendicularly to the handpiece axis Y and sealing the sealed end 71. The distal wall is adjacent to each of the walls 73A, 73B, 74A, 74B to seal the chamber at the sealed end 71 and form a cup shape of the chamber. The walls 74A, 74B can be ceramic with heater wires or tracks embedded therein or thereon. Preferably, the walls 74A and 74B with heater wires or tracks embedded therein or thereon form two ceramic heaters; these two ceramic heaters can be arranged in a polymer (for example PEEK) or metal (for example stainless steel) frame. In some examples, the walls 73A, 73B and 71 can also be ceramic.

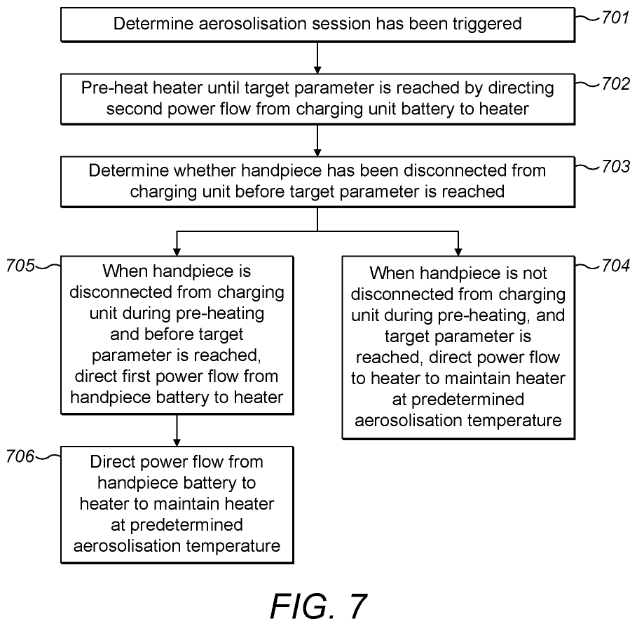

Such a ceramic heater can provide a compact heating cavity with well-distributed heat directed to the substrate. However, it can require considerably more power to heat (e.g. >>10 W and/or >>1600 J) than the heater of an aerosol generation device that is configured to receive a more traditional cigarette or cigarette-like consumable. Such heaters therefore greatly benefit from the heating power management operations subsequently with reference to FIG. 7 In other examples, each of the walls 73A, 73B, 74A, 74B, 71 can be of a thermally conductive material, such as a metal, notably a stainless steel. Additionally, at least some of the walls 73A, 73B, 74A, 74B, 71 or all of these walls can form one single piece.

The internal dimensions of the heating chamber 45 are defined by the length L3 measured according the handpiece axis Y, the width W3 measured as the distance between the chamber lateral walls 73A, 73B and the depth D3 measured as the distance between the chamber contact walls 74A, 74B. These internal dimensions L3, W3, D3 are chosen basing on the external dimensions L2, W, D of the heating portion 15 of the aerosol generating substrate 12.

The depth D3 of the heating chamber 45 can be slightly greater than the depth D of the aerosol generating substrate 12 or substantially equal to this depth D. In this case, the substrate contact walls 14A, 14B can be in contact with the chamber contact walls 74A, 74B and notably with contact surfaces of these walls 74A, 74B, when the heating portion 15 of the of the aerosol generating substrate 12 is received inside the heating chamber 45. Advantageously, in this case, the chamber contact walls 74A, 74B and notably their contact surfaces, are in a tight contact with the substrate contact walls 14A, 14B. In other examples, the depth D3 of the heating chamber 45 can be slightly less than the normal depth D of the aerosol generating substrate 12. In this case, the heating chamber 45 and/or the mouthpiece 32 is(are) configured to compress the heating portion 15 of the aerosol generating substrate 12 by exerting force on the substrate contact walls 14A, 14B. This makes it possible to improve the tight contact between the corresponding contact walls of the heating chamber 45 and the substrate 12 and thus, to improve heat transfer between these walls.

The width W3 of the heating chamber 45 can be defined so as at least one pair of facing lateral walls 73A, 13A or 73B, 13B of the heating chamber 45 and the aerosol generating substrate 12 forms an airflow channel between them. When the heating portion 15 of the aerosol generating substrate 12 is inserted in the heating chamber 45, an airflow channel is formed along the handpiece axis Y on either lateral side of the aerosol generating substrate 12. In an alternative, no airflow channel between the pairs of facing lateral walls 73A, 13A or 73B, 13B of the heating chamber 45 and the aerosol generating substrate 12 is formed. Instead, the pairs of lateral walls 73A, 13A or 73B, 13B may be in contact. This is suitable when the distal wall 71 or any other wall of the heating chamber 45 forms an opening suitable for air entering.

The walls 74A and 74B of the chamber 45 each have a heating element 47A, 47B. The heating elements 47A, 47B form the heater 47 (also referred to as a heater component) of the device. In an example, the heating elements 47A, 47B can be arranged in contact with one of the chamber contact walls 74A, 74B outside of the heating chamber 45. In the example of FIG. 4B, the heating element 47A is arranged adjacent to an outer surface of the chamber contact wall 74A and the heating element 47B is arranged adjacent to an outer surface of the chamber contact wall 47A. Thus, the chamber contact walls transfer heat from the heating elements 47A, 47B to the aerosol generating substrate 12. In other examples, the heating elements can be embedded within the chamber walls. For example, the heating element 47A can be embedded in the chamber contact wall 74A, and the heating element 47B can be embedded in the chamber contact wall 74B. In a further example, the heating elements can be on the chamber walls, internal to the heating chamber 45. As explained, the chamber walls can be a ceramic material with a heater track or wire therein or thereon. In an alternative, each heating element 47A, 47B may comprise a polyimide film heater extending along substantially the total area of the outer surface of the corresponding heating wall 74A, 74B or only along a part of this surface.

Optionally, the handpiece 10 can also include an insulator arranged between each heating element 47A, 47B and an inner surface of the housing 34. The same insulator may also be arranged between an outer surface of each of the chamber lateral walls 73A, 73B and the inner surface of the housing 34.

The handpiece 10 comprises a controller 43. The controller 43 is configured to control the operation of the handpiece 10. This can include inhibiting and enabling the operation of the device, as well as controlling a power flow of the handpiece battery 11 and the charging unit battery 51 (when connected), based upon an operating mode of the aerosol generation device 100.

The controller 43 can be at least one microcontroller unit comprising memory, with instructions stored thereon for operating the handpiece 10, including instructions for inhibiting and enabling the operation of the device, instructions for executing operating modes of the device, instructions for controlling the power flow from the battery, and the like, and one or processors configured to execute the instructions.

The controller 43 may be configured to operate separately the operation of each heating element 47A, 47B, according to a heating profile chosen among a predetermined group of heating profiles. The corresponding heating profile may be chosen according to a mode of operation of the handpiece 10 and/or according to at least some external/internal parameters relative to the operation of the handpiece 10.

The controller 43 controls a power flow to the heater 47 in the aerosolisation session, wherein an aerosolisation session can include a pre-heating phase and a heating phase.

In the pre-heating phase, the heater 47 is heated to a predetermined temperature for the generation of an aerosol from the aerosol generating substrate 12. The pre-heating phase can be considered the time during which a pre-heating mode is being executed, for example the time it takes for the heater 47 to reach the predetermined temperature. The pre-heating mode occurs during a first time period of the aerosolisation session. In an example, the first time period can be a fixed pre-determined time period. In other examples, the first time period can vary corresponding to the length of time needed to heat the heater 47 to the predetermined temperature. The predetermined temperature can be stored in memory accessible by the controller.

When the pre-heating phase is complete, the controller 43 ends the pre-heating mode and controls a power flow to the heater 47 to power the heating phase. In the heating phase, the controller 43 controls the power flow to the heater 47 to maintain the heater 47 substantially at the predetermined temperature so that an aerosol is generated for the consumer to inhale. A heating phase can be considered the time during which a heating mode is being executed, for example the time during which the heater 47 is aerosolising one (or at least part of one) aerosol generating substrate 12 after the pre-heating phase. The controller 43 can control the power flow to the heater 47 in the heating mode for a second time period of the aerosolisation session. The second time period can be predetermined and stored at the controller 43.

FIG. 6 shows an exemplary plot of average power 132 delivered to the heater 47 against time 134 for an aerosolisation session. In the pre-heating phase, the controller 43 controls the power flow to the heater 47 to apply power to the heater 47 for the first time period 136, until the heater 47 temperature reaches the predetermined temperature. In an example, the predetermined temperature may be in the range of 260 to 320° C. In an example, the first time period is 20 seconds. In some examples, the controller 43 is configured to heat the heater 47 to the predetermined temperature within a fixed predetermined first time period. In other examples, the first time period varies depending on how long the heater 47 takes to reach the predetermined temperature.

When the heater 47 reaches the predetermined temperature, the controller 43 switches the operating mode to the heating phase for the second time period 138 and maintains the heater 47 temperature substantially at the predetermined temperature for this second time period 138. In an example, the second time period may be 250 seconds. Typically, a lower power level is applied to the heater 47 in the heating phase when maintaining the heater 47 at the predetermined temperature, than the power level applied to the heater 47 to heat it to the predetermined temperature in the pre-heating phase. This can be seen in FIG. 6 in that the power delivered to the heater 47 in the second time period 138 is lower than the power delivered to the heater 47 in the first time period 136. The power level delivered to the heater 47 can be controlled by various means, for example adjusting the power output from the battery/batteries, or by adjusting the on/off periods in a pulse width modulated power flow.

Following the aerosolisation session the user of handpiece 10 may be informed that the aerosolisation session has ended, by way of a visual, haptic or audible indicator for example, so that they are aware that the substrate is no longer being aerosolised.

FIG. 7 shows an operational flow chart of a control process for power management in an aerosolisation session (such as that described with reference to FIG. 6), by which power is controlled between the handpiece battery 11, charging unit battery 51 and the heater 47 of the aerosol generation device 100 described with reference to FIGS. 1 to 5.

At step 701, the controller can be configured determine that an aerosolisation session has been triggered, with the handpiece 10 connected to the charging unit 50.

In some examples, the controller may determine that an aerosolisation session has been triggered in response to a user input, for example the pressing or operating of a button (for example an ‘ON’ button) on the aerosol generation device that a user can press or operate to begin an aerosolisation session.

In an exemplary interaction, between the operator and the device, to begin an aerosolisation session the operator may connect the handpiece 10 to the charging unit 50, and then trigger the aerosolisation session for example by pressing or operating a button.

At step 702, the controller is configured to pre-heat the heater 47 until a target parameter is reached by directing a power flow from the charging unit battery 51 to the heater 47.

In an example, the target parameter can be a predetermined time period that corresponds to a known time taken for the heater 47 to be heated to the predetermined aerosolisation temperature for a given current output from the charging unit battery 51. For example, it may be predetermined that, for the current output, a time period of 20 seconds is the pre-heating time needed to heat the heater 47 to the required aerosolisation temperature (for example in the range 260 to 320° C.) for the heating phase of the aerosolisation session. As such, the target parameter is reached when an elapsed time in the pre-heating phase reaches the predetermined pre-heating time. The controller can start a timer, for example when the aerosolisation session is triggered or when the pre-heating phase begins, and when this timer reaches the predetermined pre-heating time, the target parameter is reached.

The controller is also configured to determine whether the handpiece 10 has been disconnected from the charging unit 50 during the pre-heating.

In an example, the controller can determine that the handpiece 10 is connected to the charging unit 50 by detecting a signal between the connectors of the handpiece 10 and the connectors of the charging unit 50 when the handpiece 10 and charging unit 50 are in connection with one another. Likewise, the controller can determine that the handpiece 10 is not connected to the charging unit 50 by detecting no signal between the connectors of the handpiece 10 and the connectors of the charging unit 50 when the handpiece 10 and charging unit 50 are not in connection with one another.

At step 703, the controller determines whether the handpiece 10 has been disconnected from the charging unit 50, before the predetermined parameter is reached, during the pre-heating.

When the when the handpiece 10 has not been disconnected from the charging unit 50 during the pre-heating, and the target parameter is reached, the process proceeds to step 704. However, when the handpiece 10 has been disconnected from the charging unit 50 during the pre-heating, and the target parameter has not been reached, the process continues to step 705.

At step 704, when the handpiece 10 has not been disconnected from the charging unit 50 during the pre-heating, and the target parameter is reached, it is determined that the pre-heating phase is complete. The controller is then configured to direct a power flow to the heater 47 to maintain the heater 47 at the predetermined aerosolisation temperature in the heating phase of the aerosolisation session.

In some examples, the aerosol generation device can be configured to notify the operator that the pre-heating phase is complete. For example, the controller can control an indicator, such as one or more of a visual indicator (such as a display screen or light source, for example an LED), an audible indicator (such as a speaker emitting a sound), or a haptic indicator (such as a vibration module) to alert the operator. In this way, the operator is made aware that the device is ready to begin the heating phase and the operator can begin to inhale the generated aerosol.

Following the pre-heating phase, when the heater 47 has been pre-heated, the operator has the option of keeping the handpiece 10 connected to the charging unit 50 for the heating phase, or disconnecting the handpiece 10 from the charging unit 50, for the heating phase.

The controller can determine whether the handpiece 10 and charging unit 50 are connected by detecting whether there is a signal between the connector(s) in the handpiece 10 and the corresponding connector(s) in the charging unit 50. When the controller can detect a signal between the handpiece connectors and the charging unit connectors, the controller can determine that the handpiece 10 and charging unit 50 are in connection. When the controller cannot detect a signal between the handpiece connectors and the charging unit connectors, the controller can determine that the handpiece 10 and charging unit 50 are not in connection.

When the handpiece 10 and the charging unit 50 are disconnected for the heating phase, the controller can control a power flow from only the handpiece battery 11 to the heater 47, to power and the heater 47 in the heating phase and maintain it at the predetermined aerosolisation temperature to generate aerosol from the substrate.

This combination of powering the pre-heating phase with the charging unit battery 51, and the heating phase with only the handpiece battery 11, provides a number of advantages.

As explained, the handpiece battery 11 can have a smaller charge storage capacity than the charging unit battery 51, and therefore can be physically smaller. In turn, this means that the overall size of the handpiece 10 can be minimised as a smaller battery can be used, compared to for example, a one-part aerosol generation device that does not include have a handpiece 10 connectable to a separate charging unit 50.

On the other hand, the larger charging unit battery 51 can have a greater charge storage capacity, and a greater current output than the handpiece battery 11. The smaller handpiece battery 11 can have a lower charge storage capacity, and a lower current output than the charging unit battery 51. This means that the charging unit battery 51 can be more suited to the more energy intensive pre-heating phase. For example, a battery current of e.g. 8 A for pre-heating is a big challenge for the battery in the handpiece 10, if we refer it to its capacity. This means a 200 mAh battery would have to be able to provide 40 C discharge rate (8 A/0.2 Ah). This is very high in the lithium-ion battery space. However, for a bigger battery in the charger unit, e.g. 2000 mAh, this rate is just 4 C. This allows for a smaller size of the handpiece 10 to be achieved as the handpiece battery 11 does not need to be oversized to fulfil the power requirements.

Because the handpiece 10 is detachable from the charging unit 50, the larger charging unit battery 51 does not need to be lifted to mouth. In this case, the handpiece 10 need only be connected to the charging for the pre-heating, during which it is not being lifted the mouth of the operator. The more powerful charging unit battery 51 can heat the heater 47 more rapidly, during pre-heating, than the smaller handpiece battery 11. This allows for a quicker pre-heating than when using the handpiece battery 11 alone.

Consequently, an advantage is achieved in powering the energy intensive pre-heating of the heater 47, to quickly pre-heat, whilst also minimising the size of the handpiece 10 that is lifted to the mouth of the operator for the inhalation of the aerosol in the heating phase, and making it easier to handle. The user experience is therefore improved.

As described with reference to FIG. 1B and C, the handpiece 10 and charging unit 50 can be configured so that the mouthpiece is accessible when the handpiece 10 is connected to the charging unit 50. In this way, the operator can also inhale the generated aerosol, during the heating phase, with the handpiece 10 and charging unit 50 in connection.

When the handpiece 10 and the charging unit 50 are connected for the heating phase, the controller can control a power flow from the charging unit battery 51 to the heater 47, to power the heater 47 and maintain it at the predetermined aerosolisation temperature to generate aerosol from the substrate.

In one example in which the handpiece 10 and charging unit 50 are connected for the heating phase, the heater 47 can be exclusively powered by the charging unit battery 51. That is, the controller only controls a power flow from the charging unit battery 51 to the heater 47, and not from the handpiece battery 11. In this way, the charge stored in the handpiece battery 11 can be saved for a subsequent aerosolisation session, to allow the user to vape with the handpiece 10 and charging unit 50 disconnected for a longer period of time.

In another example, in which the handpiece 10 and charging unit 50 are connected for the heating phase, the heater 47 can be powered by a combination of the charging unit battery 51 and the handpiece battery 11. That is, the controller controls power flows from both the charging unit battery 51 and the handpiece battery 11 to the heater 47. In this way, the handpiece battery 11 with the smaller charge storage capacity and a lower current output battery can be supplemented by the charging unit battery 51 to ensure sufficient power is directed to the heater 47.

Returning to step 703, when the handpiece 10 has been disconnected from the charging unit 50 during the pre-heating, and the target parameter has not been reached, the process continues to step 705.

When the controller determines that the handpiece 10 has been disconnected from the charging unit 50 during the pre-heating phase, before the target parameter is reached, the controller can control an indictor in the device to provide an indication to the operator. For example, the controller can control an indicator, such as one or more of a visual indicator (such as a display screen or light source, for example an LED), an audible indicator (such as a speaker emitting a sound), or a haptic indicator (such as a vibration module) to alert the operator. In this way, the operator is made aware that the device is charging unit 50 is no longer powering the pre-heating phase and (as will be described subsequently) the pre-heating phase will continue powered by only the handpiece battery 11 which can take a longer time.

At step 705, when the handpiece 10 is disconnected from the charging unit 50 during the pre-heating, and before the target parameter is reached, the controller is configured to direct a power flow from the handpiece battery 11 to the heater 47 to complete the pre-heating. In this way, the handpiece battery 11 can be used to power the remainder of the pre-heating phase, to complete the pre-heating.

The power flow from handpiece battery 11 to the heater 47 during the pre-heating phase (i.e. the pre-heating power flow at step 705) can be considered a first power flow. The power flow from charging unit battery 51 to the heater 47 during pre-heating phase (i.e. the pre-heating power flow at step 702) can be considered a second power flow.

As described above, the larger charging unit battery 51 can have a greater charge storage capacity, and a greater current output than the handpiece battery 11. The smaller handpiece battery 11 can have a lower charge storage capacity, and a lower current output than the charging unit battery 51. As such, the second power flow (the power flow from charging unit battery 51 to the heater 47 during pre-heating phase), can be of a greater power than the first power flow (the power flow from handpiece battery 11 to the heater 47 during pre-heating phase). This means that when the pre-heating of the heater 47 is powered by the charging unit battery 51, a greater power can be directed to the heater 47, thereby heating the heater 47 to the predetermined aerosolisation temperature more quickly than when powering the pre-heating phase with the handpiece battery 11. Conversely, when the pre-heating of the heater 47 is powered only by the handpiece battery 11, a lower power is directed to the heater 47, thereby heating the heater 47 to the predetermined aerosolisation temperature more slowly than when powering the pre-heating phase with the charging unit battery 51.

When the entire pre-heating phase is carried out with the handpiece connected to the charging unit 50, at step 702, the power flow from the charging unit battery 51 to the heater 47 is applied for the predetermined time period that corresponds to the known time taken for the heater 47 to be heated to the predetermined aerosolisation temperature for a given current output from the charging unit battery 51. That is, when the handpiece 10 is connected to the charging unit 50, the pre-heating power flow from the charging unit battery 51 (the second power flow) is applied for the predetermined time period, and when the predetermined time period has been reached, the target parameter is met. In some examples, the second power flow is provided only by the charging unit battery 51. In other examples, the second power flow is provided by a combination of the output of both the charging unit battery 51 and the handpiece battery 11.

When the handpiece 10 is disconnected from the charging unit 50 during the pre-heating, before the target parameter is met (i.e. before the predetermined time period has been reached), the controller switches the power flow so that the heater 47 is powered only by the handpiece battery 11 (the first power flow) until the pre-heating is completed.

However, as explained, the handpiece battery 11 has a lower current output than the charging unit battery 51. That is, the first power flow from the handpiece battery 11 is of a lower power than the second power flow using the charging unit battery 51. This means that the handpiece battery 11 cannot adequately heat the heater 47 to the predetermined aerosolisation temperature in the remaining portion of the predetermined time period after the disconnection from the charging unit 50.

Instead, the controller determines a modified pre-heating time, based upon a time which has elapsed (an elapsed pre-heating time) in the predetermined time period when the handpiece is disconnected from the charging unit 50. The controller then controls the handpiece battery 11 to direct the first power flow to the heater 47 for this modified pre-heating time.

That is, the predetermined pre-heating time is the predetermined time for which the heater 47 is pre-heated using the charging unit battery 51. The elapsed pre-heating time is the time that has elapsed between the beginning of the pre-heating phase and the time at which the handpiece 10 is disconnected from the charging unit. The modified pre-heating time is the time for which the heater 47 is pre-heated using only the handpiece battery 11 after disconnection from the charging unit 50.

The modified pre-heating time can be longer than the remaining portion of the predetermined time period (Predetermined time period-Elapsed pre-heating time=Remaining portion of pre-heating time) to account for the handpiece battery 11 heating the heater 47 more slower due to its lower current output.

The controller can determine the modified pre-heating time based upon the elapsed pre-heating time by a predetermined relationship between the elapsed pre-heating time and the modified pre-heating time.

For example, a look-up table may be stored in storage accessible by the controller. This look-up table can contain values for the elapsed pre-heating time, with corresponding values for the modified pre-heating time. These modified pre-heating time values can be predetermined and correspond to the time needed to heat the heater 47 to the predetermined aerosolisation temperature when powered by only the handpiece battery 11, after the heater 47 has been partially pre-heated when powered by the charging unit battery 51 (i.e. when partially pre-heated in the elapsed time before disconnection between the handpiece 10 and charging unit 50 during the pre-heating phase). The controller determines the value for the modified pre-heating time corresponding to the elapsed pre-heating time, in the look-up table.

In an example, the predetermined heating time may be 20 seconds, when the heater 47 is powered by the charging unit battery 51 with the second power flow. The maximum modified pre-heating time may be 60 seconds, when the heater 47 is powered by only the handpiece battery 11 with the first power flow, for when the handpiece 10 is disconnected from the charging unit 50 at the very beginning of the pre-heating phase when a minimal elapsed time has occurred. With these exemplary values, the pre-heating phase can vary between 20 seconds (when powered entirely by the charging unit battery 51) to 60 seconds (when the handpiece 10 is disconnected from the charging unit 50 at the very beginning of the pre-heating phase).

Alternatively, the look-up table can contain values for the remaining portion pre-heating time with corresponding values for the modified pre-heating time. The controller can determine the remaining portion of the pre-heating time, for example, by subtracting the elapsed time when the handpiece 10 is disconnected from the charging unit 50 from the predetermined pre-heating time. The controller can then determine the corresponding value for the modified pre-heating time from the look-up table.

In another alternative, the controller may use a mathematical relationship between the elapsed pre-heating time and modified pre-heating time to determine the modified pre-heating time for a given elapsed pre-heating time. This mathematical relationship may be stored in storage accessible by the controller, and executed with a processor of the controller to calculate the modified pre-heating time for the given elapsed pre-heating time when the handpiece 10 was disconnected from the charging unit 50 during the pre-heating phase.

The controller determines the value for the modified pre-heating time based upon the elapsed pre-heating time when the handpiece 10 was disconnected from the charging unit 50 during the pre-heating phase, and then controls the handpiece battery 11 to power the heater 47 for this modified pre-heating time using the first power flow.

The pre-heating phase, at step 705, is then completed when the controller determines, using a timer, that the first power flow has been applied to the heater 47 for the modified pre-heating time.

When the pre-heating at step 705 is complete, the aerosol generation device can be configured to notify the operator that the pre-heating phase is complete. For example, the controller can control an indicator, such as one or more of a visual indicator (such as a display screen or light source, for example an LED), an audible indicator (such as a speaker emitting a sound), or a haptic indicator (such as a vibration module) to alert the operator. In this way, the operator is made aware that the device is ready to begin the heating phase and the operator can begin to inhale the generated aerosol.

When the pre-heating at step 705 is complete, the process continues to step 706.

At step 706, the controller is configured to direct a power flow from the handpiece battery 11 to the heater 47 to maintain the heater 47 at the predetermined aerosolisation temperature in the heating phase of the aerosolisation session.

Step 706 takes place when the handpiece 10 is still disconnected from the charging unit 50 for the heating phase. Alternatively or additionally, if for example the charge stored in the handpiece battery 11 is running low, the operator may reconnect the handpiece 10 to the charging unit 50 for the heating phase/during the heating phase. In this case, the heating phase can progress as described with reference to step 704.

Whilst, in the description of FIG. 7, the target parameter is a described predetermined pre-heating time period (step 702), and when the handpiece 10 is disconnected from the charging unit 50 before the predetermined time period is met, it is updated to a modified pre-heating time (step 705), alternatives are also possible.

In a first alternative, the target parameter can be the predetermined aerosolisation temperature. The controller can use a temperature sensing sub-circuit to monitor the heater temperature during the pre-heating phase. When the heater temperature reaches the predetermined aerosolisation temperature, the target parameter is reached. Then, at step 704, the controller can direct a power flow to the heater 47 to maintain the heater 47 at the predetermined aerosolisation temperature in the heating phase of the aerosolisation session, as described with reference to FIG. 7. However, when the controller determines that the handpiece 10 has been disconnected from the charging unit 50 before the heater temperature reaches the predetermined aerosolisation temperature (i.e. before the target parameter is reached) at step 703, the controller can direct the first power flow from only the handpiece battery 11 to the heater 47 (step 705). The controller can continue to monitor the heater temperature, when powered only by the handpiece battery 11, and when the predetermined aerosolisation temperature is met, the process can continue to step 706 for the heating phase. For example, if the handpiece 10 is disconnected early (step 705), the power flow is directed from the handpiece battery 11 to the heater 47 until a PID controller determines the predetermined temperature has been achieved. At this point the user is notified the device is ready to vape.

Whilst the power flow is directed from the handpiece battery 11 to the heater 47 for the preheating, at step 705, the operator can be notified by the controller controlling an indicator such as one or more LEDs to operate in a first manner (e.g. flashing). The operator can then be informed that the predetermined temperature has been achieved, and the device is ready to vape, by the controller controlling the LEDs to operate in a second manner (e.g. the flashing of the LEDs changing, stopping, or becoming solidly illuminated). Alternatively, a haptic or audio indicator may be used.

In a second alternative, the target parameter can the predetermined pre-heating time period, as described with reference to FIG. 7. When the target parameter is reached, and the handpiece 10 has not been disconnected from the process continues to step 704, as described with reference to FIG. 7. However, when the controller determines that the handpiece 10 has been disconnected from the charging unit 50 during the pre-heating phase, before the predetermined time period has been met, the controller switches the power flow so that only the handpiece battery 11 powers the heater 47 to pre-heat it (as at step 705). The controller can then monitor the heater temperature using a temperature sensing sub-circuit (instead of determining a modified pre-heating time). When the heater 47 reaches the predetermined aerosolisation temperature, the pre-heating phase is complete and process progresses to step 706 for the heating phase.

In addition to the power management processes described with reference to FIG. 7, the controller can be further configured to direct a power flow from the charging unit battery 51 to the handpiece battery 11 to charge the handpiece battery 11 when the handpiece 10 is connected to the charging unit 50. In a first example, this charging can take place between aerosolisation sessions. In a second example, the controller can be configured to direct the power flow from the charging unit battery 51 to the handpiece battery 11 to charge the handpiece battery 11 both between aerosolisation sessions and during aerosolisation sessions. In this way, the handpiece battery 11 can be charged for example during the pre-heating phase, and therefore readied for a heating phase when disconnected from the charging unit 50.

In the preceding control processes, when the handpiece 10 and the charging unit 50 are not in connection with one another the functionality performed by components in the handpiece 10 may be controlled by the controller 43 in the handpiece 10, and the functionality performed by the components in the charging unit 50 may be controlled by a controller in the charging unit 50. When the handpiece 10 and the charging unit 50 are in connection with one another, all of the functionality performed by components in the handpiece 10 and the charging unit 50 may be controlled by the controller 43 in the handpiece 10. In an alternative, when the handpiece 10 and the charging unit 50 are in connection with one another, all of the functionality performed by the components in the handpiece 10 and the charging unit 50 may be controlled by the controller in the charging unit 50. In another alternative, when the handpiece 10 and the charging unit 50 are in connection with one another some of the functionality performed by the components in the handpiece 10 and the charging unit 50 may be controlled by the controller in the charging unit 50, and some of the functionality performed by components in the handpiece 10 and the charging unit 50 may be controlled by the controller 43 in the handpiece 10.

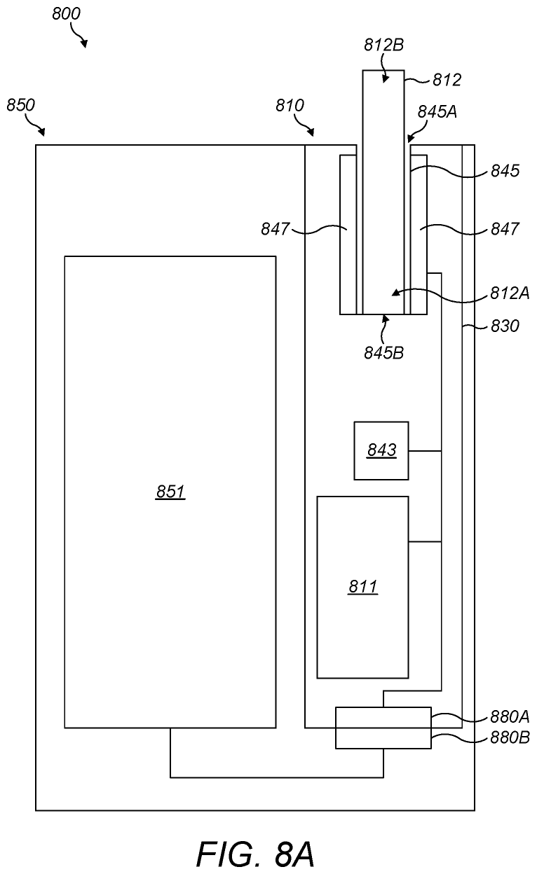

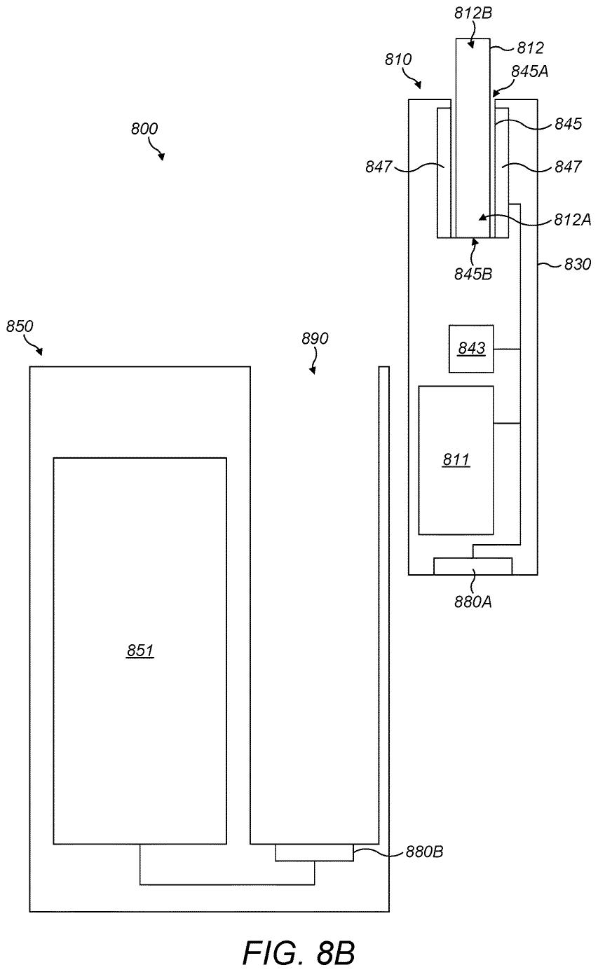

FIGS. 8A and 8B show a second exemplary aerosol generation device 800. The second exemplary aerosol generation device 800 is configured to operate in a corresponding manner to the first exemplary aerosol generation device 100, and as such, the specific detail of the operating processes are not repeated for brevity.

It will be readily understood that the operating process described with reference to the first exemplary aerosol generation device 100, and in particular the control process for power management in an aerosolisation session as described with reference to FIG. 7, can be readily applied to the second exemplary aerosol generation device 800. It will also be readily understood that the components described with reference to the first exemplary aerosol generation device 100 can be readily applied to the second exemplary aerosol generation device 800 described with reference to FIGS. 8A and 8B, even if not mentioned with reference to FIGS. 8A and 8B for brevity.

The second exemplary aerosol generation device 800 comprises a handpiece or holding unit 810 and a charging unit or charging case 850, in a similar way to the first exemplary aerosol generation device 100. The handpiece 810 is removably connectable to the charging unit 850. FIG. 8A shows the handpiece 810 connected to the charging unit 850, and FIG. 8B shows the handpiece 810 disconnected from the charging unit 850.

The handpiece 810 comprises a first charge storage module 811 configured to power a heater 847, and provide the same functionality as the first charge storage module 11 of the of the first exemplary aerosol generation device 100. The first charge storage module 811 can be one or more batteries or supercapacitors, or a combination thereof. The first charge storage module 11 can be a fast-charging battery, for example a battery with chemistry such as lithium titanate (LTO). Batteries of this type are able to deliver the high current required at the beginning of an aerosolisation session and have superior safety properties.

The charging unit 850 comprises a second charge storage module 851 that is configured to charge the first charge storage module 811 and power the heater 847, and provide the same functionality as the second charge storage module 51 of the of the first exemplary aerosol generation device 100. The second charge storage module 851 can be one or more batteries or supercapacitors, or a combination thereof.

In the following description of the second exemplary aerosol generation device 800, the first charge storage module is referred to as the handpiece battery 811, and the second charge storage module is referred to as the charging unit battery 851. However, the skilled person will readily understand that each of these can be one or more batteries, supercapacitors, or a combination thereof.

The handpiece 810 comprises a controller 843 configured to provide corresponding functionality to controller 43 in the handpiece 11 of the first exemplary aerosol generation device 100.

The handpiece 811 has a body portion or housing 830 containing the controller 843, and the handpiece battery 811. The heater or heater component 847 is contained with the body portion 830. In such an example, the heater 847 is arranged in a cavity 845 or chamber in the body portion 830. The cavity 845 is accessed by an opening 845A in the body portion 830. The cavity 845 is arranged to receive an associated aerosol generating substrate or consumable 812.

The aerosol generating substrate 812 can contain an aerosol generating material, such as a tobacco rod containing tobacco. A tobacco rod can be similar to a traditional cigarette. The cavity 845 can have a cross-section approximately equal to that of the aerosol generating substrate 812. The cavity 845 can have a depth such that when the associated aerosol generating substrate 812 is inserted into the cavity 845, a first end portion 812A of the aerosol generating substrate 812 reaches a bottom portion 845B of the cavity 845 (that is, an end portion 845B of the cavity 845 distal from the cavity opening 845A), and a second end portion 812B of the aerosol generating substrate 812 distal to the first end portion 812A extends outwardly from the cavity 845. In this way, a consumer can inhale upon the aerosol generating substrate 812 when it is inserted into the aerosol generation device 100.

In the example of FIGS. 8A and 8B, the heater 847 is arranged in the cavity 845 such that the aerosol generating substrate 812 engages the heater 847 when inserted into the cavity 845. In the example of FIGS. 8A and 8B, the heater 847 is arranged as a tube in the cavity such that when the first end portion 812A of the aerosol generating substrate is inserted into the cavity the heater 847 substantially or completely surrounds the portion of the aerosol generating substrate 812 within the cavity 845. The heater 847 can be a wire, such as a coiled wire heater, or a ceramic heater, or any other suitable type of heater. The heater 847 can comprise multiple heating elements sequentially arranged along the axial length of the cavity that can be independently activated (i.e. powered up) in a sequential order.

In an alternative embodiment (not shown), the heater can be arranged as an elongate piercing member (such as in the form of needle, rod or blade) within the cavity; in such an embodiment the heater can be arranged to penetrate the aerosol generating substrate and engage the aerosol generating material when the aerosol generating substrate is inserted into the cavity.

In another alternative embodiment (not shown), the heater may be in the form of an induction heater. In such an embodiment, a heating element (i.e., a susceptor) can be provided in the substrate, and the heating element is inductively coupled to the induction element (i.e., induction coil) in the cavity when the substrate is inserted into the cavity. The induction heater then heats the heating element by induction.

The heater 847 is arranged to heat the tobacco, without burning the tobacco, to generate an aerosol. That is, the heater 847 heats the tobacco at a predetermined temperature below the combustion point of the tobacco such that a tobacco-based aerosol is generated. The skilled person will readily understand that the aerosol generating substrate 812 does not necessarily need to comprise tobacco, and that any other suitable substance for aerosolisation (or vaporisation), particularly by heating without burning the substance, can be used in place of tobacco.

In an alternative, the aerosol generating substrate can be a vaporisable liquid. The vaporisable liquid can be contained in a cartridge receivable in the aerosol generation device, or can be directly deposited into the aerosol generation device. The charging unit 850 is dimensioned to receive and accommodate the handpiece 810 within an opening 890 in the charging unit 50. The charging unit battery 851 connects by connectors 880B in the charging unit opening 890 to corresponding connectors 880A in the handpiece 10 when the handpiece 810 is received in the charging unit 850. A controller in the handpiece 810 or the charging unit 850 can detect a signal between the handpiece connectors 880A and the charging unit connectors 880B and control a power flow from the charging unit battery 851 to the handpiece battery 811.

When received in the charging unit 850, the handpiece 810 can be arranged such that the cavity 845 is accessible from the opening 890 in the charging unit 850. In this way, an aerosol generating substrate 812 can be inserted into the cavity 845 when the handpiece 810 is connected to (or received in) the charging unit. Moreover, the consumer can then perform an aerosolisation session when the handpiece 810 is connected to (or received in) the charging unit by inhaling upon the accessible end 812B of the substrate 812 that extends from the handpiece 810 and charging unit 850.

As already described, the second exemplary aerosol generation device 800 can perform the same operations for an aerosolisation session, particularly regarding the pre-heating phase and heating phase of an aerosolisation session, the charging unit battery charging the handpiece battery, and the operations described with reference to FIG. 7 as those described with reference to the first exemplary aerosol generation device. For brevity, these are not repeated again here.

In the preceding examples, the processing steps described herein carried out by the controller of the handpiece, or the controller of the charging unit, may be stored in a non-transitory computer-readable medium, or storage, associated with the respective controller. A computer-readable medium can include non-volatile media and volatile media. Volatile media can include semiconductor memories and dynamic memories, amongst others. Non-volatile media can include optical disks and magnetic disks, amongst others.

It will be readily understood to the skilled person that the preceding embodiments in the foregoing description are not limiting; features of each embodiment may be incorporated into the other embodiments as appropriate.

1. An aerosol generation device comprising a holding unit configured to receive and aerosolise an aerosol generating substrate, and a charging unit that is connectable to the holding unit;
the holding unit comprising a heater component configured to aerosolise the aerosol generating substrate, and a first charge storage module configured to power the heater component;
the charging unit comprising a second charge storage module configured to power the heater component;
the aerosol generation device further comprising a controller configured to:
when the holding unit is connected to the charging unit, pre-heat the heater component until a target parameter is reached by directing a second power flow from the second charge storage module to the heater component; and
when the holding unit is disconnected from the charging unit during pre-heating and before the target parameter is reached, direct a first power flow from the first charge storage module to the heater component.

2. The aerosol generation device of claim 1, wherein the first power flow corresponds to a lower current output from the first charge storage module than a current output from the second charge storage module for the second power flow.

3. The aerosol generation device of claim 1, wherein the target parameter is a predetermined pre-heating time.

4. The aerosol generation device of claim 3, wherein the controller is configured to direct the first power flow from the first charge storage module to the heater component for a modified pre-heating time when the holding unit is disconnected from the charging unit during pre-heating and before the target parameter is reached, wherein the modified pre-heating time is longer than a remaining portion of the predetermined pre-heating time at a time point when the holding unit is disconnected from the charging unit.

5. The aerosol generation device of claim 4, wherein the controller is configured to determine the modified pre-heating time based upon an elapsed pre-heating time when the holding unit is disconnected from the charging unit during pre-heating.

6. The aerosol generation device of claim 5, wherein the controller is configured to determine the elapsed pre-heating time between a beginning of pre-heating and a-the time point when the holding unit is disconnected from the charging unit during pre-heating; and
determine the modified pre-heating time based upon the elapsed pre-heating time by a predetermined relationship between the elapsed pre-heating time and the modified pre-heating time.

7. The aerosol generation device of claim 1, wherein the controller is configured to maintain the heater component at a predetermined aerosolisation temperature when the heater component has been pre-heated, and the holding unit is disconnected from the charging unit, by directing a power flow from the first charge storage module to the heater component.

8. The aerosol generation device of claim 1, wherein the controller is configured to maintain the heater component at a predetermined aerosolisation temperature when the heater component has been pre-heated, and the holding unit is not disconnected from the charging unit, by directing a power flow from the second charge storage module to the heater component.

9. The aerosol generation device of claim 1, wherein the controller is configured to, when the holding unit is connected to the charging unit, direct a power flow from the second charge storage module to the first charge storage module to charge the first charge storage module.

10. The aerosol generation device of claim 1, wherein the holding unit comprises a cavity into which an aerosol generating substrate is insertable for heating with the heater component to generate an aerosol, wherein the cavity is configured to receive an aerosol generating substrate that is substantially planar in shape; and
the cavity comprises two major internal faces, wherein the two major internal faces oppose one another, the aerosol generating substrate is configured to be received between the opposing major internal faces, and the major internal faces are each associated with a heating element of the heater component.

11. The aerosol generation device of claim 10, wherein the major internal faces comprise a ceramic material and the heating elements are arranged on or embedded in the ceramic material.

12. The aerosol generation device of claim 1, wherein the holding unit comprises a cavity into which an aerosol generating substrate is insertable for heating with the heater component to generate an aerosol, wherein the cavity is configured to receive an aerosol generating substrate that is rod shaped.

13. An aerosol generation system comprising the aerosol generation device of claim 1 having an aerosol generating substrate received in the holding unit of the aerosol generation device.

14. A method of operating an aerosol generation device, the aerosol generation device comprising:
a holding unit configured to receive and aerosolise an aerosol generating substrate and a charging unit that is connectable to the holding unit, the holding unit comprising a heater component configured to aerosolise the aerosol generating substrate, and a first charge storage module configured to power the heater component, the charging unit comprising a second charge storage module configured to power the heater component;
wherein the method comprises:
when the holding unit is connected to the charging unit, pre-heating the heater component until a target parameter is reached by directing a second power flow from the second charge storage module to the heater component; and
when the holding unit is disconnected from the charging unit during pre-heating and before the target parameter is reached, directing a first power flow from the first charge storage module to the heater component.

15. A non-transitory computer-readable medium storing instructions executable by one or more processors of an aerosol generation device, the aerosol generation device comprising:
a holding unit configured to receive and aerosolise an aerosol generating substrate and a charging unit that is connectable to the holding unit, the holding unit comprising a heater component configured to aerosolise the aerosol generating substrate, and a first charge storage module configured to power the heater component, the charging unit comprising a second charge storage module configured to power the heater component;
wherein the instructions cause the one or more processors to perform steps comprising:
when the holding unit is connected to the charging unit, pre-heating the heater component until a target parameter is reached by directing a second power flow from the second charge storage module to the heater component; and
when the holding unit is disconnected from the charging unit during pre-heating and before the target parameter is reached, directing a first power flow from the first charge storage module to the heater component.
